(19) United States
(12) Patent Application Publication
(10) Pub. No.: US 2011/0256973 A1
(43) Pub. Date: Oct. 20, 2011

(54) DRIVE TRAIN WITH A FIRST ELECTRIC MOTOR AND A PLANETARY GEAR MECHANISM AS WELL AS WIND ENERGY PLANTS, GAS TURBINES AND WATER TURBINES AND VEHICLES THAT HAVE THIS DRIVE TRAIN

(75) Inventors: Ernst August Werner, Aachen (DE); Christoph Teetz, Friedrichshafen (DE); Christian Beiner, Salem (DE)

(73) Assignees: MTU FRIEDRICHSHAFEN GMBH, FRIEDRICHSHAFEN (DE); ISATEC GMBH, AACHEN (DE)

(21) Appl. No.: 12/998,835

(22) PCT Filed: Dec. 1, 2009
(86) PCT No.: PCT/DE2009/001695

§ 371 Date: Jun. 24, 2011

(30) Foreign Application Priority Data
Dec. 9, 2008 (DE) 10 2008 060 871.8
May 4, 2009 (DE) 10 2009 019 485.1

(51) Int. Cl. F16H 3/72

(52) U.S. Cl. 475/5; 180/65.21; 903/902

(57) ABSTRACT

A drive train, wherein the drive train has a first electric machine (EMI) which can be operated in a motor or generator operating state, and a planetary gear mechanism (100) having a rotational-speed changing apparatus, wherein the rotational-speed changing apparatus is configured, in particular, as an internal gear (110) and/or as a planetary gear (114) and/or as a sun gear (112), wherein the planetary gear mechanism (100) has a drive side and a driven side, characterized in that the first electric machine (EMI) engages into the rotational-speed changing apparatus in a controlling manner in the motor or generator operating state, with the result that a step-up transmission ratio is formed in the planetary gear mechanism (100).

The invention relates to a drive train, the drive train having a first electrical machine, which is operable in a motor or generator operation mode, and a planetary gear mechanism with a rotational-speed changing apparatus, the rotational-speed changing apparatus being designed more specifically as an internal gear and/or as a planet gear and/or as a sun gear, the planetary gear mechanism having a drive side and a driven side.

The coupling of electrical machines with gears has been known for a long time. In recent years, such drive trains have become very popular in the motor vehicle branch. The advantage of such drives are that braking energy, which is usually dissipated as heat, is stored in an energy store and is available to the drive as needed.

Gears in which a rotational-speed transformation occurs by means of electrical machines are also known in the prior art. The simplest embodiment of such a gear is one where mechanical energy is transformed into electric energy and where the electric energy drives an electric motor. The entire mechanical energy is thereby transformed into electric energy and lost energy. This leads to a disadvantageous degree of efficiency.

In other embodiments of the prior art, electro-magnetic planets, which are switchable by changing the planet gears in such a manner that a determined gear ratio can be adjusted, are used in mechanical gears. Such designs have a very complex mechanical and electrical implementation.

In some hybrid concepts, the electrical machines are designed with the same dimensions as the combustion engine. This involves an additional weight, which must also be moved by a conventional drive or the electric drive.

The object of the invention is to improve the prior art.

The object is solved by a drive train, the drive train having a first electrical machine, which is operable in a motor or generator operation mode, and a planetary gear mechanism with a rotational-speed changing apparatus, the rotational-speed changing apparatus being designed more specifically as an internal gear and/or as a planetary gear and/or as a sun gear, the planetary gear mechanism having a drive side and a driven side, the first electrical machine intervening to control the rotational-speed changing apparatus in the motor or generator operation mode, so that a pre-determined gear ratio forms in the gear.

A drive train of the type described here can be used more specifically as a motor or as a generator. When used as a motor, it is used more specifically for locomotion. When used as a generator, it is used more specifically for generating electrical energy

The first electrical machine used here can be used for motor or generator operation. The operation mode is more specifically determined by switching the first electrical machine. Thus, a rotational speed can be applied (in two directions) to the driving and driven rotational speed changing apparatus in the motor area of the first electrical machine, which makes it possible to almost continuously adjust a gear ratio. This analogically applies to the generator area of the first electrical machine. In these designs, the intervention in the rotational-speed apparatus occurs without changing the localization of the planet, internal or sun gears.

In the generator operation mode, a rotational speed is applied to the first electrical machine by means of the planet gear mechanism, more specifically electric energy being generated.

The first electrical machine can additionally be operated in such a manner that it virtually “runs along”. In this operation mode, no rotational speeds are applied to the rotational-speed change apparatus and the rotational-speed change apparatus does not apply a rotational speed to the electrical machine. This operation mode can be implemented by a mechanical stop and/or uncoupling from the drive train.

In the generator operation mode of the first electrical machine, the rotational-speed change apparatus can apply rotational speeds to the electrical machine which lead to the production of electricity.

The controlling intervention into the rotational-speed changing apparatus substantially occurs by the first electrical machine applying a rotation to the rotational-speed change apparatus or receiving a rotation in the motor or generator operation mode, the first electrical machine developing a more specifically in a controlling resistance in this mode. The gear ratio of the planetary gear mechanism can thus be influenced by means of the first electrical machine.

It is thereby most particularly advantageous if the planetary gear mechanism can be switched almost continuously by means of the first electrical machine.

In order to impinge a gear ratio on the planetary gear mechanism with as low a torque expense as possible, the first electrical machine can intervene to control the sun gear in the motor and generator operation mode. Additionally, the first electrical machine can thus be centrally flanged on the planetary gear mechanism. A compact configuration of the drive train can thus be implemented.

In another design of the drive train, the first electrical machine can be connected to an energy store. Thus, energy from the energy store can advantageously be supplied to the first electrical machine and, during generator operation mode, be applied to the energy store by the first electrical machine. Batteries, capacitors and/or fuel cells and/or an electricity network can be used as an energy store.

In order to transfer mechanical output via the drive train, a mechanical energy device can be flanged to the planetary gear mechanism on the drive side. The surface mounting is thereby designed in such a manner that mechanical energy can be applied to the drive train.

In an embodiment of the invention, the mechanical energy device can be designed as a combustion engine. A hybrid drive (combination of a mechanical and electrical machine) can thereby be advantageously implemented. Such a combustion engine is furthermore adapted for use in all motor vehicles.

In order to transform more specifically mechanical energy into electrical energy, the mechanical energy device can be configured as a gas turbine, a rotor of a water turbine or a rotor of a wind energy plant.

In an embodiment of the invention, in case the mechanical energy device transfers an output to the planetary gear mechanism, the first electrical machine can be in a generator operation mode, the first electrical machine generating electric energy. Thus, mechanical energy can advantageously be transformed into electric energy.

In order to provide electric energy at different moments, the electric energy generated by the first electrical machine can be supplied to the energy store.

In another embodiment of the invention, the drive train can have an energy management control system, which regulates the energy flow between the energy store and the first electrical machine. Different objectives can thus be implemented by the drive train as required. Thus, it is possible on the one hand to fill the energy store when empty by means of the first electrical machine or to actuate the planet gear mechanism via the first electrical machine with the energy from the energy store. The energy management control system can also be used for controlling and thus for configuring the operation mode.

In a related embodiment of the invention, the energy management control system can include a controller which interprets sensor data from the mechanical energy device and controls the first electrical machine via a determined variable. The sensor data can more specifically be the rotational speed, the output and/or emission values of the combustion engine. Thus, the current output of the combustion engine can be determined by means of a CO2 sensor or a CO sensor for instance, and by controlling the gear ratio via the first electrical machine the gear can be actuated in such a manner that the combustion engine operates in an optimal range. Sensor data from the driven side such as the frequency of the electricity network for instance can also serve as sensor data for controlling the first electrical machine.

In order to implement a compact drive train, the electrical machine can have an electrical nominal output and the mechanical energy device can have a mechanical nominal output, the first electric nominal output amounting to between 0 and 50 percent of the mechanical nominal output in an embodiment.

In another embodiment of the invention, the first electric nominal output can amount to between 10 and 35 percent of the mechanical nominal output.

In another embodiment of the invention, the first electric nominal output can amount to between 15 and 25 percent and most preferably approximately 20 percent of the mechanical nominal output. With such a percentage an optimal control of the planetary gear mechanism can more specifically be implemented.

In order to implement a more effective hybrid drive, the drive train can have a second electrical machine which is operable in a motor and generator operation mode and is located on the driven side. In this embodiment, a hybrid drive is implemented in which the planetary gear mechanism can be continuously regulated by means of the first electrical machine and the second electrical machine can contribute to the drive and to energy generation.

In order to implement optimal configurations of the drive train, the second electrical machine can have a second electric nominal output which has a second electric nominal output amounting to between 0 and 150 percent. Furthermore, the second electric nominal output can amount to between 10 and 35 percent or 15 and 25 percent or most preferably approximately 20 percent. Combined with the first electrical machine, an optimal drive train, in which an output or weight/space ratio can more specifically be adjusted, can be implemented in this manner.

In order to apply energy to the energy store, respectively to draw energy from the energy store, the second electrical machine can be connected to the energy store and also preferably to the energy management control system.

In another embodiment of the invention, the energy management control system can regulate the electric current between the energy store and the second electrical machine. A performance of the second electrical machine depending on the operation mode can thus be implemented in a controlled manner. More specifically, the hybrid performance can thereby be controlled.

Such an operation dependent state can more specifically include the case of a boat towing another boat (e.g. a sailing boat). The behavior of a sensor value (e.g. rotational speed) can thereby be logged during a first acceleration. During subsequent accelerations, it is possible to accordingly intervene in the gear. If the situation changes again (the towed boat is uncoupled), the change of rotational speed during another first acceleration is logged and allows a controlling intervention in the gear during subsequent accelerations.

In order for the first electrical machine to supply the second electrical machine with energy, the second electrical machine can be configured with an electrical conductive connection to the first electrical machine.

In a related embodiment, the energy management control system can regulate the electric current between the first and second electrical machines. In order for the second electrical machine to apply energy to the drive train with a low energy loss, the second electrical machine can be located on the driven side.

In order to more specifically allow a start-up of the combustion engine, the drive train can have a first brake on the driven side. In this embodiment, the first electrical machine can more specifically support the start-up of the combustion engine via the planetary gear mechanism. This can more specifically occur by the first electrical machine applying a rotational speed to the combustion engine, which can thus be started more easily.

In order to implement a purely electrical drive, the drive train can have a second brake on the drive side. The drive side can thus be uncoupled from the driven side.

In order to be able to transfer output from the drive side to the driven side in case of a breakdown of the first or the second electrical machine, the drive train can have a coupling between the drive side and the driven side, which, when engaged, directly transfers output from the mechanical energy device to the driven side. A redundant system can thus be advantageously constructed.

In another embodiment of the invention, the mechanical energy device, when disengaged, can transfer output via the internal gear of the planetary gear mechanism. Thus, a high torque can be advantageously transferred via the planetary gear mechanism.

In order to provide the energy store with a redundant system, the drive train can have an auxiliary power unit which supplies the first and/or the second electrical machine with electric energy. In a ship, this can more specifically be the already available auxiliary power unit which supplies the ship with electric energy.

In another embodiment of the invention the energy management control system can include a controller which interprets sensor data from the mechanical energy device and controls the second electrical machine, the coupling and/or the brake via a determined variable. An optimal intervention in the actuators can thereby be advantageously implemented.

The object is furthermore solved by a rail vehicle, more specifically a train or a tramway, the rail vehicle having a drive train as described above. The drive train can thus be advantageously used in a rail vehicle.

In another aspect of the invention, the object is solved by a motor vehicle, more specifically a truck, a car, a bus, a tank or a construction vehicle, the motor vehicle having a drive train as described above. The drive train can thus be advantageously used in a motor vehicle.

In another aspect of the invention, the object can be solved by a water vehicle, more specifically a ship, a yacht, a boat, or a jet-ski, the water vehicle having a drive train as described above. Environmentally friendly water vehicles can thus be advantageously provided. The environmental friendliness of the drive train (including for the embodiments described above) can more specifically result from the fact that the pollutant emission of the combustion engine leads to a control of the planetary gear mechanism, which makes it possible to operate the combustion engine in an environmentally optimal way.

In another aspect of the invention, the object can be solved by an aircraft, more specifically a propeller-drive airplane, and the aircraft having a drive train as described above. Thus, an environmentally friendly aircraft can be advantageously provided.

In a further aspect of the invention, the object can be solved by a wind energy plant which has a drive train as described above. Thus, a continuously controlled wind energy plant can be advantageously provided.

In order to apply an electric current having the network frequency (network synchronized use) to the electricity network, the wind energy plant can generate a substantially constant rotational speed on the drive side and on the driven side by means of the first electrical machine.

In another aspect of the invention, the object can be solved by a wind energy plant farm which includes at least one wind energy plant as described above. Such a wind energy plant farm is also frequently referred to as a wind farm, and is substantially characterized in that several wind energy plants are simultaneously operated in one location and at least one wind energy plant of the wind energy plant farm is submitted to a wind energy plant farm effect. Such effects are more specifically a reduction of wind energy for wind energy plants standing behind one another in the direction of the wind.

In another aspect of the invention, the object can be solved by a gas turbine having a drive train as described above.

In another aspect of the invention, the object is solved by a gas turbine arrangement having at least one gas turbine as described above.

In another aspect of the invention, the object can be solved by a water turbine having a drive train as described above.

In a related further aspect of the invention, the object can be solved by a water turbine arrangement having at least one water turbine as described above.

In another aspect of the invention, the object can be solved by a method for start-up of one of the vehicles described above, more specifically a rail vehicle, a motor vehicle, a water vehicle or an aircraft, the start-up occurring substantially electrically. Thus, a silent and low-pollutant start-up can be advantageously implemented, more specifically since the combustion engine does not have to be operated during the start-up.

In order to ensure an optimal transmission of the output, the second electrical machine can work in a motor operation mode in this method.

In a further embodiment of the method, the first electrical machine can thereby substantially be in an idle operation mode. The first electrical machine can thereby be operated advantageously in a resource-saving manner.

In another aspect of the invention, the object can be solved by a method for substantially continuously driving one of the previously described vehicles, more specifically a rail vehicle, a water vehicle, a motor vehicle, or an aircraft, the output required on the driven side being substantially supplied by the mechanical energy device. This can prove advantageous, since the mechanical energy device can thus be operated in an optimal state for a long period of time.

In a related embodiment of the method, a first part of the output required on the driven side can be supplied mechanically via the planetary gear mechanism and a second part of the output required on the driven side via the first electrical machine, which operates in the generator operation mode, and by the second electrical machine—supplied by the first electrical machine.

The combustion engine can in turn be operated in an optimal range by the part provided by the first electrical machine to the second electrical machine, the first electrical machine then generating an electric current for the second electrical machine. This can prove to be very environmentally friendly. The corresponding control can be implemented by the energy management control system.

In another aspect of the invention, the object can be solved by a method for charging the energy store of a drive train as described above, a part of the output generated on the drive side being supplied to the energy store via the first and/or second electrical machine. Depending on the charge status required on the drive side, the energy store can thus be advantageously charged. When driving downhill or during standstill, the energy supplied by a combustion engine can thus be completely transformed into electric energy which is supplied to the energy store.

In another aspect of the invention, the object can be solved by a method for accelerating a vehicle, more specifically a rail vehicle, a motor vehicle, a water vehicle or an aircraft as described above, the second electrical machine being supplied by the energy store and more specifically by EM1. More output than is supplied by the combustion engine can thus be applied advantageously to the system for a short time.

In another aspect of the invention, the object can be solved by a method for decelerating a vehicle, more specifically a rail vehicle, a motor vehicle, a water vehicle or an aircraft as described above, energy being applied to the energy store via the second and/or first electrical machine during a deceleration. Thus, the energy store can be charged advantageously by recuperating the braking energy. This leads to a partial transformation of the braking energy into electric energy and to this energy being applied to the energy store.

In another aspect of the invention, the object is solved by a method for operating a water vehicle, the operation being subdivided into driving, partial gliding and gliding, an electrical machine in a motor operation mode contributing in addition to a combustion engine to an acceleration of the water vehicle during driving. The definition of gliding, partial gliding and driving can be gathered from the book “Motorkreuzer und schnelle Sportboote (Ausgabe von 1970)” (Motor Cruisers and Rapid Pleasure Craft (Edition of 1970)) by Juan Baader (more specifically from the illustrations 9 and 45). The related content is an integral part of the present application.

Thus, in a hybrid drive, additional energy can be summoned up to bridge the energetically disadvantageous driving as quickly as possible.

In a related embodiment of the invention, the water vehicle is a water vehicle as described above. More specifically, the first and/or second electrical machine can thereby contribute to the acceleration.

In an embodiment of the method, the second electrical machine can contribute to an acceleration of the water vehicle up to a maximum power coefficient Cp (see “Motorkreuzer und schnelle Sportboote (Ausgabe von 1970)” (Motor Cruisers and Rapid Pleasure Craft (Edition of 1970)) by Juan Baader, illustration 45). More specifically, shortly after the maximum power coefficient Cp (at higher speeds R), a partial gliding of the water vehicle is implemented. From this it follows that the actual output which must be supplied for propulsion of the water vehicle can be reduced. In this method the electrical machine is more specifically configured as the second electrical machine described above.

In another aspect of the invention, the object is solved by a method for controlling a vehicle, an expected course profile being lodged and the vehicle including a combustion engine and an electrical machine, a function (course of the function of the course profile) of the electrical machine being developed in relation to the expected course profile. The current position of the vehicle can more specifically be gathered from satellite navigation or from the known driving cycle.

A drive train can thus react in preparation of expected outputs. The lodged course profile includes parameters such as acclivity or declivity, or the length of an almost horizontal course profile

In a related embodiment of the method, the vehicle can be configured as a vehicle as described above, and the electrical machine can be configured as the second electrical machine. The hybrid drive as described here can thus be advantageously used.

In another aspect of the invention, the object is solved by a method for leaving or entering a harbor with a water vehicle, the water vehicle having a combustion engine and an electrical machine with an energy store, leaving and entering occurring by means of the electrical machine. The sound pollution in the harbor can thus be advantageously reduced. Additionally, pollutants being added to the harbor water can be reduced.

In a related embodiment of the method, the water vehicle can be configured as a water vehicle as described above.

In another aspect of the invention, the object can be solved by a device for developing a drive train, the device having a combustion engine, an output shaft, a first electrical machine, a second electrical machine and a gear coupled to the combustion engine, the gear having an internal gear, a sun gear and a planet carrier, the first electrical machine having a controlling coupling with the sun gear and the second electrical machine being coupled to the output shaft and the combustion engine applying a torque to the output shaft via the internal gear. This concrete embodiment makes it possible to advantageously control the gear transmission ratio via the first electrical machine.

In another aspect of the invention, the object is solved by an electrical drive train, the electrical drive train having a drive train as described above, the mechanical energy device being replaced by an electric energy device. Thus, an electrically controllable gear for electric drive trains can be provided.

In a related embodiment of the invention, an electric motor (EM3) can be the electric energy device.

The invention is further described in the following by means of exemplary embodiments. In the drawings:

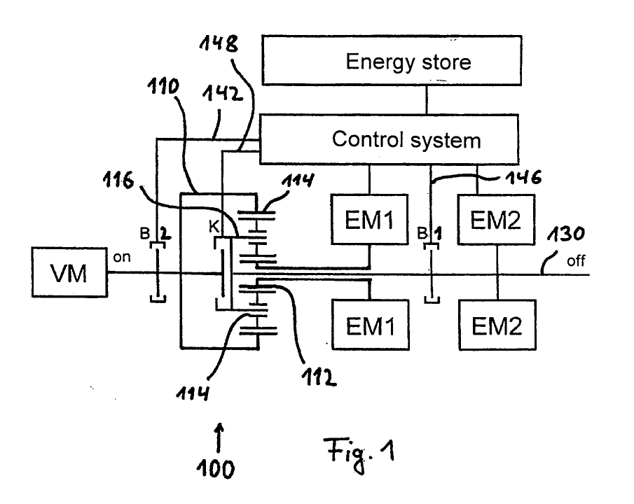

FIG. 1: shows a schematic view of a drive train with a combustion engine and an energy store and

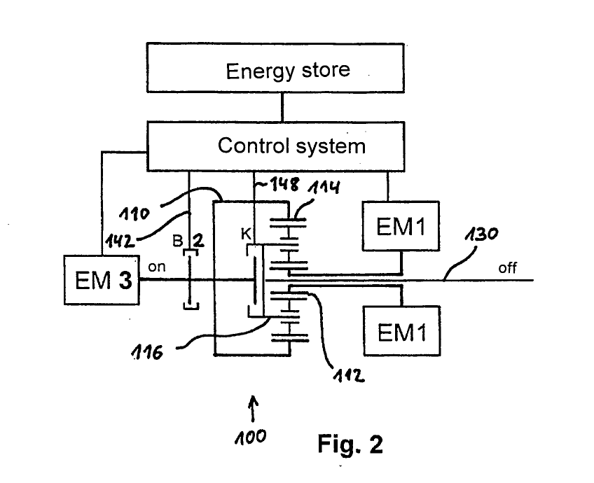

FIG. 2: a schematic view of a drive train, the main drive being an electrical machine.

The planetary gear mechanism 100 in FIG. 1 has an internal gear 110, planet gears 114 and a sun gear 112. The combustion engine VM is flanged to the internal gear 110 on the drive side. The drive side is labeled “an”. The first electrical machine EM1 is flanged to the sun gear 112.

The sun gear 112 is configured as a hollow shaft. A shaft 130 is led to the driven side through the hollow shaft. The driven side is labeled “ab”. The brake B1 is disposed on the shaft 130. The brake can lock the shaft 130.

The brake B2, which can stop the hollow shaft with regard to the combustion engine, is located on the drive side.

The second electrical machine EM2 is flanged to the shaft 130. Thus, the second electrical machine EM2 can apply a torque to the shaft 130. The shaft 130 can also apply a torque to the electrical machine EM2, which the second electrical machine EM2 transforms into electric energy in a generator operation mode.

The shaft 130 is connected to the planetary gear mechanism 100 via the planet carrier 116. If the combustion engine VM applies a rotation to the hollow gear 110, this rotation is transferred to the shaft 130 via the planet wheel 114 and the planet carrier 116.

By applying a rotation to the sun gear 112, the first electrical machine EM1 influences the gear ratio in the planetary gear mechanism 100. The first electric motor EM1 is connected to the energy store as well as to the second electrical machine EM2 via the energy management control system (“control system”). The energy management control system thereby controls the electric current from EM1 to the energy store and back, the energy flow from EM2 to the energy store and back and the electric current from the first electrical machine EM1 to the second electrical machine EM2 and vice versa.

The energy management control system (“control system”) thereby also records sensor values from the combustion engine, the energy store and the driven side, or in case of a connection to an electricity network, sensor values from the electricity network. The energy, management control system (“control system”) communicates via control cables (142, 146, 148) with the couplings K and the brakes B1, B2, so that the output can be adapted optimally to the given conditions.

In this embodiment, the gear ratio of the planetary gear mechanism 100 is influenced via the first electrical machine EM1. The operating point of the combustion engine is thereby also determined. Thus it is possible to operate the combustion engine close to the optimal degree of efficiency, in order to minimize the fuel consumption and the resulting CO2 emission.

In case of a breakdown of the electrical machines EM1 or EM2, the combustion engine can drive the driven shaft 130 directly via the coupling K. A redundant system is thus created.

The arrangement shown in FIG. 1 can be used more specifically for vehicles. The following driving conditions can thereby be implemented:

Start-Up (Purely Electrical Operation)

If the charge status of the energy store is sufficient, the start-up occurs purely electrically, that is to say that the combustion engine VM is off or uncoupled. The second electrical machine EM2 works as a motor, the necessary output being drawn from the energy store. The first electrical machine EM1 is idling or used as an additional drive.

Normal Running (Charging the Energy Store)

The output required in this vehicle status is exclusively delivered by the combustion engine VM. A great part of the mechanical energy generated by the combustion engine VM is thereby routed to the driven shaft 130 via the planetary gear mechanism 100.

Another part of the mechanical energy is transformed into electric energy by the first electrical machine EM1 and directly transferred to the second electrical machine EM2. Should it be required by the charge status of the energy store, a part of the electric energy generated by the first or second electrical machine is fed to the energy store. This is implemented in a controlled manner by the energy management control system.

Acceleration

Accelerations are supported by the second electrical machine EM2 (also referred to as electrical machine), the output of the second electrical machine EM2 resulting from the electric output transferred by the first electrical machine EM1 operating as a generator in this operation mode, and from the output drawn from the energy store. This output supplied by the first electrical machine EM1 is applied to the shaft 130 via the second electrical machine EM2.

Deceleration

During deceleration, the energy store can be charged by recuperation of the braking energy. At least one of the two electrical machines EM1 and EM2 works as a generator in this operating mode, the generated electric energy being then applied to the energy store.

If another mechanical energy source is mounted instead of the combustion engine VM, for instance a rotor of a wind energy plant or a rotor of a gas or water turbine, the device (drive train) can be used for generating energy.

The generated electric energy is provided as synchronized with the network by controlling the gear ratio by means of the first electrical machine EM1. In this mode, the second electrical machine EM2 more specifically serves as a generator. This generator has substantially the nominal output supplied by the rotor.

FIG. 2 shows an electric drive train. The electric motor EM3 thereby is the electric energy device. The functioning occurs analogously to the drive train in FIG. 1, the second electrical machine EM2 being not mentioned here. The electric drive train represented here forms an electrically controllable planetary gear mechanism 100 which can be driven by an electric motor. An electric drive with an integrated speed adjustment is thus substantially created.

The electric motor can also be configured as an electrical machine. This also allows a recuperation of the energy.

1-61. (canceled)

62. A drive train, the drive train having a first electric engine (EM1) and a second electric engine (EM2) which are both operable in a motor or generator operation mode, a combustion engine (VM) and planet gear mechanism (100) with a rotational speed changing apparatus, the rotation speed changing apparatus being designed more specifically as an internal gear (110) and/or as a planetary gear (114) and/or as a sun gear (112), and the planet gear mechanism (100) having a drive side and a driven side, the combustion engine being flanged on the drive side and the second electric engine (EM2) being located on the drive side and the second electric engine (EM2) being flanged to the shaft (130) on the driven side, so that a torque can be applied to the shaft (130) by the second electric engine (EM2) or applied by the shaft to the second electric engine (EM2) in a generator operation mode, wherein the first electric engine (EM1) steeredly intervenes in the rotational speed changing apparatus, so that a transmission ratio can be almost continuously adjusted.

63. The drive train according to claim 62, the first electric engine and/or the second electric engine being connected to an energy store.

64. The drive train according to claim 63, an energy management control system regulating an electric current between the energy store and the first electric engine and/or the second electric engine.

65. The drive train according to claim 62, the second electric engine having an electrically conductive connection with the first electric engine.

66. The drive train according to claim 62, the first electric engine in a motor or generator operation mode steeredly intervening in the sun gear.

67. A rail vehicle, more specifically a train or a tramway, the rail vehicle having a drive train according to claim 62.

68. A power vehicle, more specifically a truck, a car, a bus, a tank or a construction vehicle, the power vehicle having a drive train according to claim 62.

69. A water vehicle, more specifically a ship, yacht, boat or jet-ski, the water vehicle having a drive train according to claim 62.

70. An aircraft, more specifically a propeller airplane, the aircraft having a drive train according to claim 62.
